(19) United States
(12) Patent Application Publication
(10) Pub. No.: US 2013/0114038 A1
(43) Pub. Date: May 9, 2013

(54) EYEGLASSES WITH REPLACEABLE TEMPLES

(71) Applicant: SHU-FENG HUANG, Tainan (TW)

(72) Inventor: SHU-FENG HUANG, Tainan (TW)

(21) Appl. No.: 13/291,118

(22) Filed: Nov. 8, 2011

(51) Int. Cl. G02C 5/14; G02C 3/00

(52) U.S. Cl. 351/116; 351/156

(57) ABSTRACT

Eyeglasses with replaceable temples include a lens rim having two sides respectively provided with a projecting member with at least one insert hole. Two connecting bases are respectively assembled at two sides of the lens rim, respectively having a front end disposed with an insert slot, an inner wall bored with at least one insert hole communicating with the insert slot and an outer wall formed with a recessed groove having its interior bored with at least one insert hole communicating with the insert slot. Two positioning plates are respectively received in the recessed grooves of the connecting bases, respectively having an inner side secured with at least one positioning stud respectively having a threaded hole. Two screw members are inserted through the insert holes of the connecting bases and screwed in the threaded holes of the positioning stud.

### BACKGROND OF THE INVENTION

1. Field of the Invention

This invention relates to a pair of eyeglasses with replaceable temples, particularly to one whose temples can conveniently and quickly be replaced with other temples of different styles and different functions so that the eyeglasses can be used on different occasions and for different purposes.

2. Description of the Prior Art

A pair of eyeglasses is generally composed of a lens rim assembled thereon with lenses and two temples. Two sides of the lens rim and the front end of the two temples are respectively and oppositely provided with a pivotal lug with an insert hole, and the two temples are respectively and pivotally combined at two sides of the lens rim by means of screws that are inserted in the insert holes of the corresponding pivotal lugs. However, it is impossible for general eyeglasses to replace two temples with an elastically constrictive band for facilitating a user to wear the eyeglasses when the user take physical exercises, and hence a user has to additionally purchase sports eyeglasses for use. Thus, a user has to increase expenses in purchasing various eyeglasses to be used for different purposes and on different occasions, and the user must carry along general eyeglasses and sports eyeglasses for use at the same time, taking too much space for placing the eyeglasses and inconvenient in use.

### SUMMARY OF THE INVENTION

The objective of this invention is to offer eyeglasses with replaceable temples, facilitating the temples of the eyeglasses to be quickly replaced with various temples of different styles and different functions to meet needs of different occasions and different purposes.

The eyeglasses with replaceable temples in the present invention include a lens rim, two connecting bases, two positioning plates and two temples. The lens rim has two opposite sides respectively provided with a projecting member bored with at least one insert hole. The two connecting bases are respectively assembled at two sides of the lens rim, respectively having a front end disposed with an insert slot, and an inner wall bored with at least one insert hole communicating with the insert slot and an outer wall formed with a recessed groove having its interior bored with at least one insert hole communicating with the insert slot. The two positioning plates are respectively received in the recessed grooves of the two connecting bases, respectively having an inner side fixed with at least one positioning stud with a threaded hole. The positioning stud is inserted through the insert hole in the recessed groove of the connecting base and into the insert hole of the lens rim, with a screw member inserted through the insert hole at the inner side of the connecting base and then threadably locked in the threaded hole of the positioning stud. The two temples are respectively combined with the rear ends of the two connecting bases.

Eyeglasses with replaceable temples in the present invention includes a lens rim having two opposite sides respectively formed with a projecting member that is bored with at least one insert hole. Two connecting bases are respectively assembled at the two sides of the lens rim, respectively having a front end provided with an insert slot and an inner wall bored with at least one insert hole communicating with the insert slot, and further having an outer wall disposed with a recessed groove having its interior bored with at least one insert hole communicating with the insert slot. Two positioning plates are respectively received in the recessed grooves of the two connecting bases, respectively having an inner side secured with at least one positioning stud with a threaded hole. The positioning stud is inserted through the insert hole in the recessed groove of the connecting base and into the insert hole of the lens rim, and a screw member is inserted through the insert holes at the inner side of the connecting base and then threadably locked in the threaded hole of the positioning stud. An elastically constrictive band is connected with the rear ends of the two connecting bases.

### BRIEF DESCRIPTION OF DRAWINGS

This invention will be better understood by referring to the accompanying drawings, wherein:

FIG. 1 is an exploded perspective view of a pair of eyeglasses with replaceable temples in the present invention;

FIG. 2 is a perspective view of the pair of eyeglasses with replaceable temples in the present invention;

FIG. 3 is a cross-sectional view of a temple combined with a lens rim in the present invention; and

FIG. 4 is a perspective view of the pair of eyeglasses having the original connecting bases replaced with new connecting bases that are connected with an elastic tightening band to be used as sports eyeglasses in the present invention.

### DETAILED DESCRIPTION OF THE PREFERRED EMBODIMENT

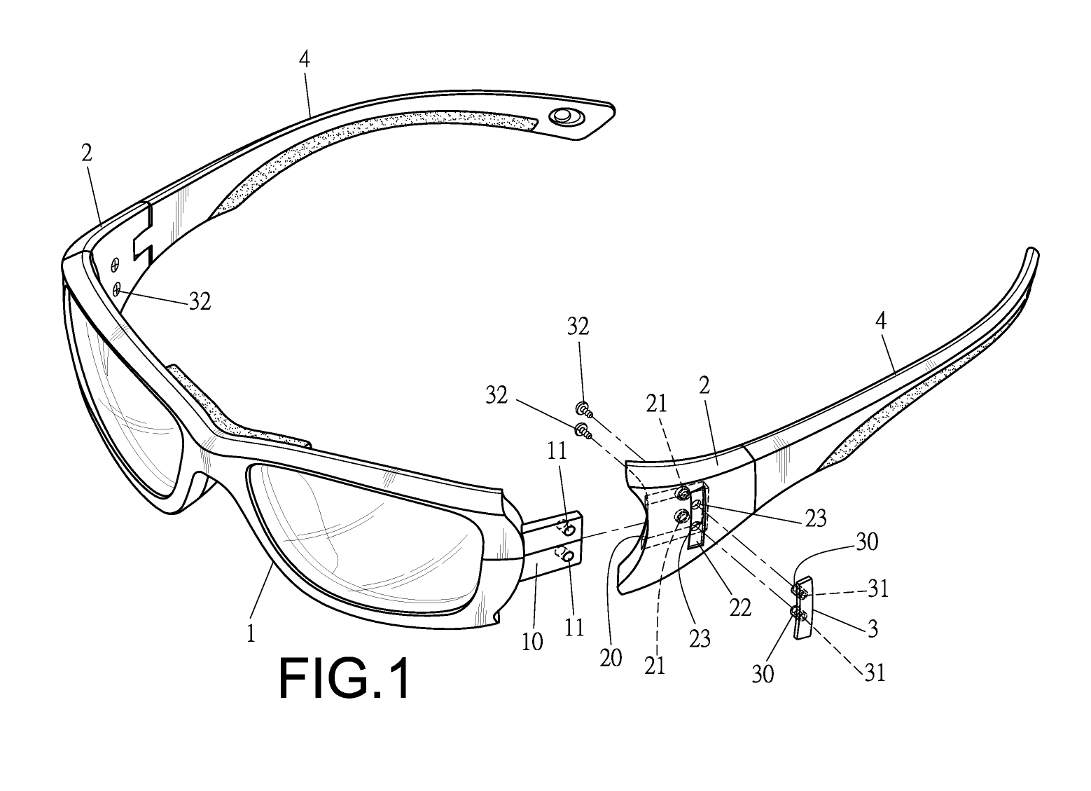

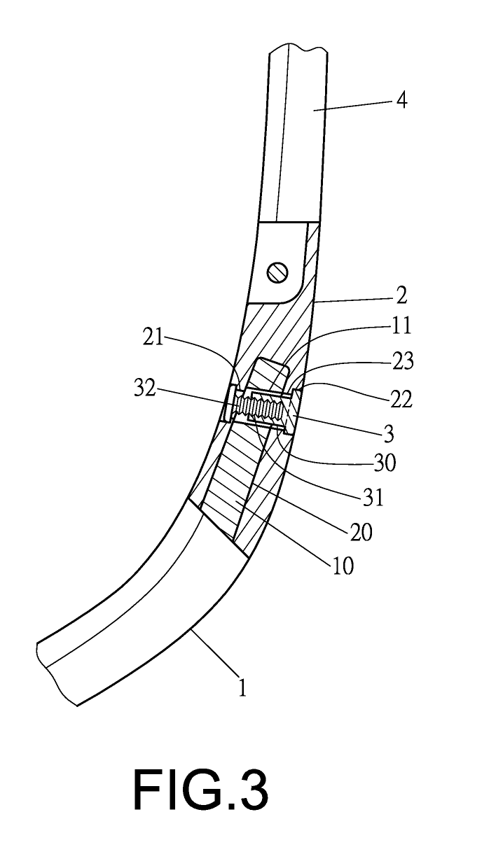

A preferred embodiment of eyeglasses with replaceable temples in the present invention, as shown in FIGS. 1-3, includes a lens rim 1, two connecting bases 2, two positioning plates 3 and two temples 4 as main components combined together.

The lens rim 1 has two opposite sides respectively provided with a projecting member 10 with two insert holes 11.

The two connecting bases 2 are respectively assembled at the two sides of the lens rim 1, respectively having a front end disposed with an insert slot 20, and an inner wall bored with two insert holes 21 communicating with the insert slot 20 and an outer wall formed with a recessed groove 22 bored therein with two insert holes 23 communicating with the insert slot 20.

The two positioning plates 3 made of metal are respectively received in the recessed grooves 22 of the two connecting bases 2. Each positioning plate 3 has its inner side provided with two positioning studs 30 respectively having a threaded hole 31. The two positioning studs 30 of each positioning plate 3 are respectively inserted through the insert holes 23 in the recessed groove 22 and into the insert holes 11 of the lens rim 1, and plural screw members 32 are respectively inserted through the insert holes 21 at the inner side of the connecting base 2 and then threadably locked in the threaded holes 31 of the positioning studs 30.

The two temples 4 are respectively and pivotally combined with the rear ends of the two connecting bases 2.

In assembling, referring to FIGS. 1-3, two temples 4 with a style a user likes are first respectively and pivotally combined with the rear end of the connecting base 2 and then, the projecting members 10 at the two opposite sides of the lens rim 1 are respectively inserted in the insert slots of the two connecting bases 2, letting the insert holes 11 of the projecting member 10 of the lens rim 1 aligned to the insert holes 21 and 23 of the connecting base 2. Afterward, the positioning plates 3 are respectively received in the two recessed grooves 22 of the two connecting bases 2 to have the positioning studs 30 on the positioning plate 3 inserted through the insert holes 23 in the recessed grooves 22 of the connecting base 2 and the insert holes 11 of the lens rim 1. Subsequently, the screw members 32 are respectively inserted through the insert holes 21 at the inner side of the connecting base 2 and then threadably locked in the threaded holes 31 of the positioning plate 3 to firmly combine the lens rim 1 together with the connecting bases 2.

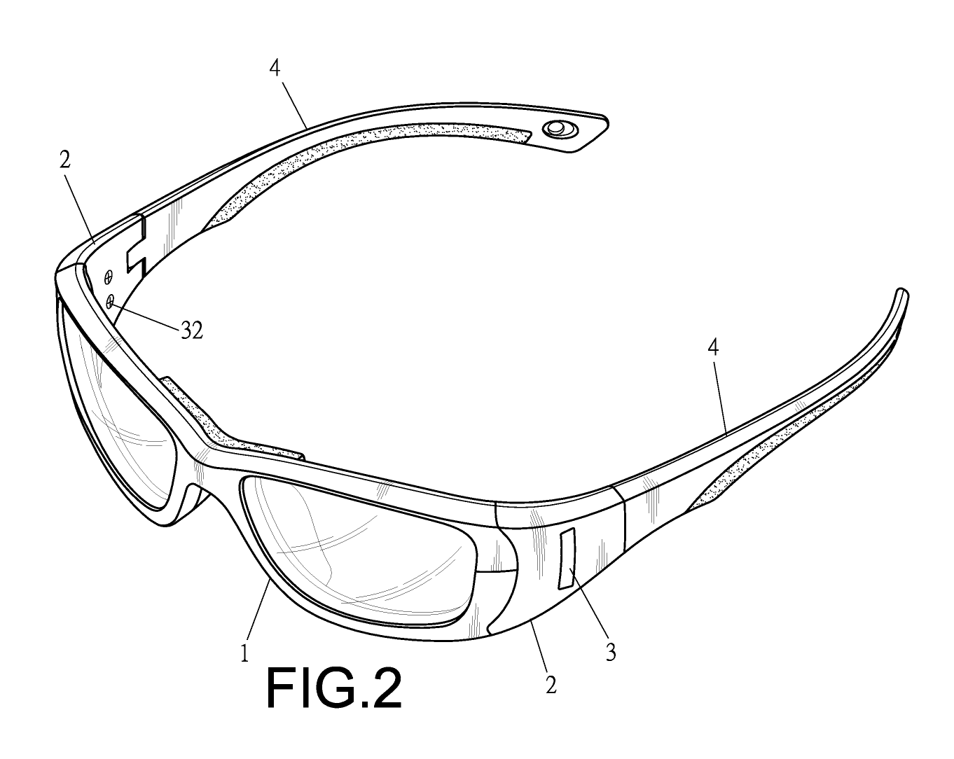

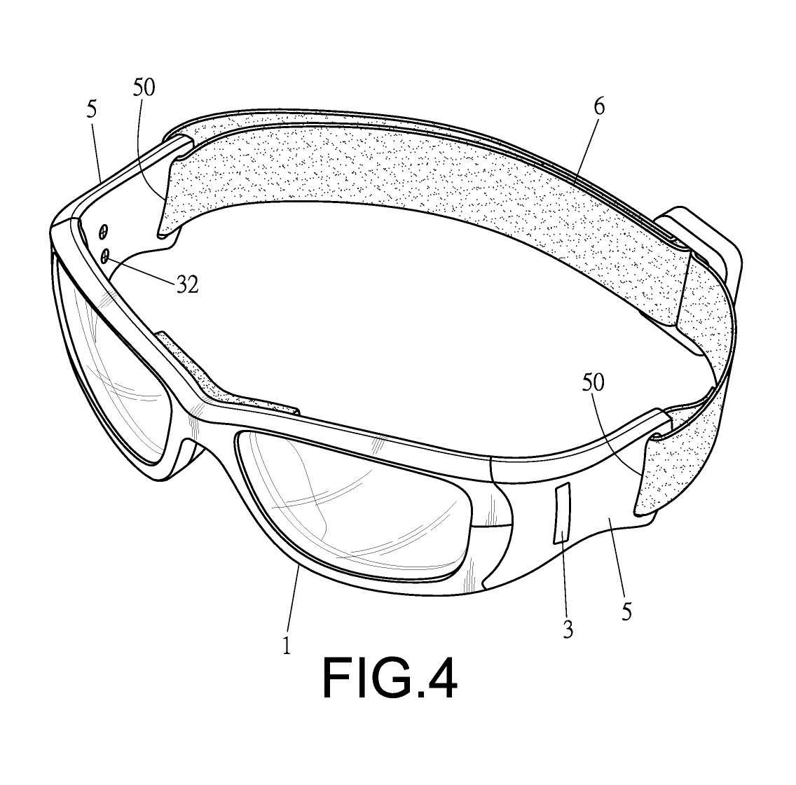

In using, referring to FIGS. 2 and 4, when the eyeglasses of this invention are to be used as general eyeglasses, only have the connecting bases 2 together with the pivotally connected temples 4 respectively assembled at the two opposite sides of the lens rim 1. Thus, different styles of temples 4 can easily be replaced for use in accordance with needs of matching with clothes. On the other hand, to have the eyeglasses of this invention used as sports eyeglasses, simply remove the connecting bases 2 together with the temples 4 from the lens rim 1 and have new connecting bases 5 with an elastically constrictive band 6 assembled on the lens rim 1, as shown in FIG. 4. The two connecting bases 5 are respectively bored with an insert slot 50 for two ends of the elastically constrictive band 6 to be respectively inserted therethrough. Thus, the eyeglasses can be constricted on a wearer's head by the elastically constrictive band 6 to make up a pair of sports eyeglasses to be used when taking physical exercises.

To sum up, the temples of the eyeglasses of this invention can conveniently and quickly be replaced with various temples to meet needs of different purposes and different occasions, able to greatly reduce cost of purchasing eyeglasses of different styles and different functions.

While the preferred embodiments of the invention have been described above, it will be recognized and understood that various modifications may be made therein and the appended claims are intended to cover all such modifications that may fall within the spirit and scope of the invention

What is claimed is:

1. Eyeglasses with replaceable temples comprising:
a lens rim having two sides respectively provided with a projecting member, said projecting member bored with at least one insert hole;
two connecting bases respectively assembled at two sides of said lens rim, said connecting base having a front end provided with an insert slot, said connecting base having an inner wall bored with at least one insert hole communicating with said insert slot, said connecting base having an outer wall formed with a recessed groove, said recessed groove having an interior bored with at least one insert hole communicating with said insert slot;
two positioning plates respectively received in said recessed grooves of said two connecting bases, said positioning plate having an inner side fixed with at least one positioning stud, said positioning stud bored with a threaded hole, said positioning stud inserted through said insert hole in said recessed groove of said connecting base and into said insert hole of said lens rim, a screw member inserted through said insert hole at an inner side of said connecting base and threadably locked in said threaded hole of said positioning stud; and
two temples respectively and pivotally combined at rear ends of said two connecting bases.

2. Eyeglasses with replaceable temples comprising:
a lens rim having two sides respectively provided with a projecting member, said projecting member disposed with at least one insert hole;
two connecting bases respectively set at two sides of said lens rim, said connecting base having a front end formed with an insert slot, said connecting base having an inner wall bored with at least one insert hole communicating with said insert slot, said connecting base having an outer wall provided with a recessed groove, said recessed groove having an interior bored with at least one insert hole communicating with said insert slot;
two positioning plates respectively received in said recessed groove of said two connecting bases, said positioning plate having an inner side fixed with at least one positioning stud, said positioning stud bored with a threaded hole, said positioning stud inserted through said insert hole in said recessed groove of said connecting base and into said insert hole of said lens rim, a screw member inserted through said insert hole at an inner side of said connecting base and threadably secured in said threaded hole of said positioning stud; and
an elastically constrictive band connected with two rear ends of said two connecting bases.
